(19) United States
(12) Patent Application Publication
(10) Pub. No.: US 2024/0069160 A1
(43) Pub. Date: Feb. 29, 2024

(54) OPTIMIZING DETECTION PERFORMANCE OF RADIO FREQUENCY BASED SENSING

(71) Applicant: SIGNIFY HOLDING B.V., EINDHOVEN (NL)

(72) Inventors: HUGO JOSÉ KRAJNC, EINDHOVEN (NL); PETER DEIXLER, ARLINGTON, MA (US); INO DEKKER, EINDHOVEN (NL)

(21) Appl. No.: 18/272,157

(22) PCT Filed: Jan. 10, 2022
(86) PCT No.: PCT/EP2022/050314

§ 371 Date: Jul. 13, 2023

Related U.S. Application Data
(60) Provisional application No. 63/137,361, filed on Jan. 14, 2021.

(30) Foreign Application Priority Data
Jan. 22, 2021 (EP) 21152869.0

(51) Int. Cl. G01S 7/40; G06F 11/30; G06F 11/34

(52) U.S. Cl. CPC G01S 7/40; G06F 11/3006; G06F 11/3093; G06F 11/3409; G01S 13/56

(57) ABSTRACT

The present invention relates to a radio frequency (RF) system with multiple nodes (34, 36, 38, 44, 46, 48) and a method for optimizing detection performance for performing RF-based sensing in a sensing area (32) based on RF system configuration parameters. An RF system configuration parameter of the RF system configuration parameters which affects detection performance of the RF-based sensing the most is determined. The RF system configuration parameter which affects detection performance of the RF-based sensing the most is then adjusted in order to optimize the detection performance of RF-based sensing. A root cause for a diminished detection performance and the respective RF system configuration parameter for mitigating it may be determined based on current context. For optimizing the detection performance, for example, settings of sensing parameters of the nodes (34, . . . , 48) may be adjusted or the nodes (34, . . . , 38) may be moved, removed, added, or replaced.

### FIELD OF THE INVENTION

The present invention relates to a radio frequency (RF) system, a method for optimizing detection performance of RF-based sensing, and a computer program product.

### BACKGROUND OF THE INVENTION

RF-based sensing is used for detecting different types of sensing events in a sensing area, such as human motion or room-occupancy, e.g., used for controlling light settings, as well as more detailed human biometric features like a rate of breathing movements or human gait, e.g., used for context awareness and detailed daily activity monitoring.

US 2017/366938 A1 shows a system for detecting the presence of a body in a network using signal absorption, and signal forward and reflected backscatter of RF waves caused by the presence of a biological mass in a communications network. The system may automate various aspects of setup, particularly with regards to grouping nodes into detection areas and building levels of functionality nominally based on machine learning methods. A system which determines nearest nodes and estimates detection areas through inference requires no setup by a user. Based upon best estimates, a user may simply place nodes throughout a building, and the nodes automatically group into detection areas using unsupervised machine learning, ultimately resulting in a building system learning how to detect occupants.

US 2020/0096345 A1 shows a computer-implemented method for cognitive fingerprinting of an indoor location. The method comprises determining calibration information for using a sensing device within an indoor environment; generating instructions corresponding to one or more suggested location sensor placements throughout the indoor environment based at least in part on the calibration information; and issuing the instructions corresponding to the one or more suggested location sensor placements via the sensing device while a user operating the sensing device navigates the indoor environment. The suggested location sensor placements may be based on one or more received signal strength indicators (RSSIs), each RSSI being received by the sensing device and from a location sensor within the indoor environment. The instructions may comprise an instruction to place a new location sensor in a location where a signal strength received from one or more proximate location sensors is less than a predetermined minimum signal strength threshold.

### SUMMARY OF THE INVENTION

It can be seen as an object of the present invention to provide an RF system, a method for optimizing detection performance for performing RF-based sensing, a computer program product for optimizing detection performance for performing RF-based sensing, and a computer readable medium which allow an improved optimization of the detection performance for performing RF-based sensing.

In a first aspect of the present invention an RF system for optimizing detection performance for performing RF-based sensing based on RF system configuration parameters is presented. The RF system comprises multiple nodes of which a group of at least two nodes is configured for performing RF-based sensing in a sensing area. The RF system is configured for determining an RF system configuration parameter of the RF system configuration parameters which affects detection performance of the RF-based sensing the most. Additionally, the RF system is configured for adjusting the RF system configuration parameter which affects the detection performance of the RF-based sensing the most in order to optimize the detection performance of RF-based sensing.

Since the RF system is configured for determining the RF system configuration parameter of the RF system configuration parameters which affects detection performance of the RF-based sensing the most and for adjusting the RF system configuration parameter which affects the detection performance of the RF-based sensing the most in order to optimize the detection performance of RF-based sensing, a root cause affecting the detection performance negatively, may be mitigated. This allows an improved optimization of the detection performance. Which of the RF system configuration parameters affects the detection performance the most depends on the root cause which negatively affects the detection performance. This allows determining which adjustment to the RF system allows to mitigate the root cause the most and therefore allows to improve detection performance the most.

Affecting the detection performance the most means that an adjustment to the RF system configuration parameter which affects the detection performance of the RF-based sensing the most, has a larger effect on the detection performance than a corresponding adjustment to another RF system configuration parameter. For example, one of the RF system configuration parameters may be a location of a first node and another one of the RF system configuration parameters may be a location of a second node. Moving the first node by a certain length in vertical direction may have only a small effect on the detection performance, while moving the second node by the same length in vertical direction may have a much larger effect on the detection performance. For example, if the RF system is arranged in a sensing area in form of a room for performing breathing rate recognition of two different persons laying in a double bed and the first node is a ceiling luminaire arranged at a center of a ceiling of the room while the second node is a bedside lamp arranged on a bedside table on one side of the double bed, moving the bedside lamp in vertical direction has a much larger effect on recognizing the breathing rate of the person laying in the double bed on the side on which the bedside lamp is arranged compared to moving the ceiling luminaire. Moving the ceiling luminaire in general has a much smaller effect on breathing rate recognition than moving the bedside lamp as the ceiling luminaire is in much larger distance to the persons in the double bed.

In contrast to optimizing other sensing modalities such as passive infrared (PIR) sensors, cameras, radar, or the like, RF-based sensing presents a unique characteristic as it is a distributed sensing modality. Unlike PIR sensors, camera, radar, etc. there is not a single, physically identifiable device that performs the sensing. Instead, a group of nodes generate data among them, processes the data, e.g., involving sensing algorithms or sensing analysis algorithms of various complexity, and as a group conclude on whether a sensing event occurred. Therefore, for example, a different number of nodes or different relative locations of the nodes to each other in different groups may influence detection performance of RF-based sensing for the different groups.

When performing sensing using other sensing modalities than RF-based sensing, a field of view (FoV) of the sensing device, e.g., a camera, may be adjusted by turning a camera lens of the camera into a direction of a desired new sensing area in order to improve detection performance. In the case of RF-based sensing, improving detection performance by adjusting the sensing area, e.g., modifying a detection area of the group that performs RF-based sensing, is not trivial. The RF-based sensing may be influenced by the locations of the nodes but also, for example, by complex multi-path effects. The RF signals are not confined to pre-defined FoVs with clear cut-offs. Furthermore, presence of tangible entities, such as objects, in the sensing area may alter multi-path behaviour.

The RF system may allow to determine which RF system configuration parameter affects the detection performance the most and to adjust this RF system configuration parameter which affects the detection performance of RF-based sensing the most in order to improve the detection performance. The RF system may also be used to provide feedback to a user for improving detection performance.

RF-based sensing allows for the detection of various sensing events taking place in a sensing area, i.e., a specific space or specific volume, such as a room in a building, a building, or any other space. Sensing algorithms or sensing analysis algorithms may detect and analyse how tangible entities, such as objects or users, within the sensing area affect RF signals. RF signals are used for transmitting RF messages. RF-based sensing may be used as means for detecting and classifying sensing events, such as user activity in homes, offices, etc. For example, based on WiFi RF-based sensing messages being transmitted and received by nodes in form of smart lights, RF-based sensing may determine motion in a room and turn lights on or off automatically, nodes in form of WiFi routers may estimate breathing rate of people, etc.

The underlying principle for RF-based sensing is that distortions of RF signals in a space are both a function of the tangible entities in it, e.g., moving objects, as well as of the frequency of the RF signals. Radio waves are propagated through electromagnetic radiation and interact with an environment by reflection, refraction, diffraction, absorption, polarization, and scattering. Wireless attenuation is different for different materials within a typical frequency range used by RF-based sensing applications. Therefore, characteristics of the sensing area, e.g., a construction form of a room, a spatial arrangement, and integral-surface-area of each material type present in the sensing area may influence RF multipath signal characteristics of the sensing area.

For performing RF-based sensing, one node may act as a transmitting node transmitting RF signals including RF messages to another node acting as a receiving node. The received RF signals may then be analysed. If the RF signals interact with one or more tangible entities, e.g., objects or persons, on their transmission paths between the nodes, the RF signals are disturbed, such as scattered, absorbed, reflected, or any combination thereof. These disturbances can be analysed and used for performing RF-based sensing. The disturbed and/or reflected RF signals can include an RF-based sensing fingerprint based on signal parameters, such as real and imaginary part of electrical permittivity and magnetic susceptibility. Performing RF-based sensing by at least two nodes is also called passive RF sensing.

A first node of the at least two nodes may be configured for transmitting radio frequency signals and a second node of the at least two nodes may be configured for receiving the transmitted radio frequency signals, and wherein the radio frequency based sensing may be performed by analysing disturbances to the radio frequency signals caused by interaction of the radio frequency signals with one or more objects or persons on their transmission paths between the at least two nodes. The analysis may be based on comparing the received radio frequency signals with a baseline defined for the sensing area. The baseline may comprises propagation of radio frequency signals in the sensing area. A person skilled in the art of (passive) RF sensing is aware of obtaining/determining baselines, thus not further discussed here.

The radio frequency system may be configured to perform presence detection in the sensing area. The radio frequency system may be configured to perform one or more of motion detection, location tracking, vital signs detection such as breathing detecting, heart rate monitoring, sleep monitoring, fall detection, posture detection, activity detection, gait detection, gesture detection, etc., in the sensing area. Other known or future applications of the radio frequency sensing are not excluded. The presence detection may be an explicit detection of presence of a user, or it may be implicitly derived from other sensing functions related to the presence of a user, such as motion detection, location tracking, health-related detections (such as breathing detection, heart rate detection, fall detection etc.).

The RF system configuration parameters may relate to the RF system configuration parameters for the at least two nodes forming the group that performs RF-based sensing in the sensing area or the multiple nodes, i.e., all nodes of the RF system including the at least two nodes of the group which performs RF-based sensing in the sensing area. Operation of nodes that are not included in the group which performs RF-based sensing in the sensing area may affect the detection performance, for example, due to wireless interference or clogging of the wireless network of the RF system.

The RF system configuration parameters may include one or more of:
a spatial arrangement of the at least two nodes of the group,
a grouping of the multiple nodes into the group,
a number of nodes in the group,
capabilities of the nodes in the group, and
one or more sensing parameters for performing RF-based sensing.

The RF system configuration parameters influence the detection performance. Depending on a setting of the RF system configuration parameters the detection performance may be higher or lower. This allows optimizing the detection performance by adjusting one or more of the RF system configuration parameters. Since the RF system configuration parameter which affects the detection performance the most is adjusted, optimization may be improved.

The spatial arrangement of the at least two nodes of the group may include, a spatial arrangement of the nodes with respect to each other, with respect to nodes of other groups, as well as with respect to other tangible entities, e.g., walls, corners, or other objects, such as a double bed or bookshelf. The spatial arrangement may also include a relative location of at least one of the two nodes to other tangible entities. The spatial arrangement of the nodes of the group may be adjusted, for example, by moving one or more of the at least two nodes. Movement may be performed in any three dimensional direction, i.e., horizontally, vertically, or a combination thereof. Adjusting the spatial arrangement may allow to improve the detection performance, e.g., by adjusting the sensing area and/or by moving a node closer to an area of interest in which a sensing event is expected to occur. For example, a bedside lamp may be moved closer to a side of a double bed which corresponds to an area of interest for breathing rate recognition since a user is expected to sleep on that bed side. This may allow improving detection performance of the beside lamp for breathing rate recognition.

The RF system may be configured for determining which node to remove, replace, or move in order to improve the detection performance the most, e.g., by comparing the detection performance for different spatial arrangements. For example, moving the ceiling luminaire would only have a smaller effect on improving detection performance. Therefore, the RF system may be configured for determining based on a computer simulation, actually moving the ceiling luminaire, information regarding the root cause that negatively affects the detection performance, or information regarding the RF system configuration parameters, e.g., received by a user, which node may be moved in order to have the largest effect on the detection performance, corresponding to determining the RF system configuration parameter which affects the detection performance the most.

The grouping of the multiple nodes into the group may be adjusted by removing a node of the at least two nodes, adding a node from the multiple nodes, e.g., from another group of the RF system, to the group that performs RF-based sensing in the sensing area, or a combination thereof, such as replacing, for example, one node with another node. The RF system may be configured for only adding a node of another group to the group performing RF-based sensing in the sensing area if the other group is able to operate without the node. The RF system may be configured for determining an effect that removing a node from another group and adding the node to the group for performing RF-based sensing in the sensing area may have on the other group, as well as on the group in order to decide whether the node should be moved.

The number of nodes in the group for performing RF-based sensing in the sensing area may be adjusted by removing a node from the group or adding a node to the group, e.g., by regrouping the nodes of the RF system and/or by removing or adding a node to the RF system.

Sensing parameters may include, for example, a transmit power, a sensitivity, a signal strength, a signal link, a beam shape, a directionality of a beam, a threshold level, a type of radio used for performing RF-based sensing, a communication protocol used for performing RF-based sensing, or any other sensing parameter. The threshold level may be, for example, a threshold level of sensitivity, a threshold level of signal strength, or any other threshold level. The type of radio used for performing RF-based sensing may be different for different nodes, for example, a first node may use 2.4 GHz WiFi, while a second node and a third node may use 2.4 GHz WiFi and additionally 5 GHz WiFi. The communication protocol used for performing RF-based sensing may include for example, Bluetooth, Bluetooth low energy (BLE), WiFi, cellular radio, Zigbee, or any other communication protocol which can be used for performing RF-based sensing.

The RF system may be configured for determining the RF system configuration parameter which affects the detection performance of the RF-based sensing the most based on a current context. This allows to dynamically adjust the RF system configuration parameter which affects detection performance the most in order to optimize the detection performance of RF-based sensing. The RF system may be configured for determining the current context for performing RF-based sensing by the group in the sensing area or for the entire RF system. Information regarding the current context may be provided by a user as input to the RF system which is then processed by the RF system in order to determine the current context. Alternatively, the RF system may be configured for determining the current context in any other way, e.g., based on data stored in the RF system or sensor data obtained by the RF system.

The current context may include one or more of:
a setting of one or more of the RF system configuration parameters,
a sensing application,
a latency requirement,
an expected sensing event in the sensing area,
a privacy requirement,
a radio power consumption requirement,
a radio transmit power requirement,
a radio beam shape requirement,
a radio receive beamforming requirement,
a current location of the RF system,
a current location of at least one of the at least two nodes,
a current location of a tangible entity in the sensing area,
a current date,
a current operation mode of at least one of the at least two nodes,
environmental effects,
currently available bandwidth in the RF system,
current capabilities of the at least one of the at least two nodes,
current properties of the sensing area,
a false event detection rate requirement, and
a missed event detection requirement.

The RF system may be configured for determining the setting of the one or more of the RF system configuration parameters by checking the current stored setting of the RF system configuration parameters.

The sensing application may include, for example, which type of sensing event is to be detected by performing RF-based sensing, such as a snappy, low-latency motion detection, occupancy detection, vacancy detection, fall detection, heartbeat detection, breathing rate recognition, heart rate recognition, or any other sensing event. The sensing application may also provide a current context by including requirements of the sensing application, such as standby-power requirements for the sensing application, e.g., a currently required standby-power level.

The current context may also include different sensing applications, e.g., ranked by priority of the sensing applications in order to provide certain sensing functionalities. For example, the sensing applications may include occupancy detection and breathing rate recognition. The occupancy may have a lower priority than the breathing rate recognition such that adjusting a location of a node which improves detection performance for breathing rate recognition but reduces detection performance for occupancy detection may be performed by the RF system, but not for the opposite case in which detection performance for breathing rate recognition is reduced and detection performance for occupancy detection is improved. This may allow to improve detection performance based on a prioritization of sensing applications.

The latency requirement may include, for example, a certain time duration within which the processing of the data needs to be completed and the sensing event needs to be either detected or not, e.g., for life-safety-critical sensing applications which require a fast reaction. Another latency requirement may for example be a lighting control latency requirement according to which lighting needs to be activated within a certain time duration, e.g., 200 ms, in response to a user entering the sensing area.

The expected sensing event in the sensing area may be any sensing event detected by performing RF-based sensing for a certain sensing application, such as occupancy detection, fall detection, breathing rate recognition, heart rate recognition, gesture recognition, or the like.

The privacy requirement may include, for example, that certain RF-based sensing applications are not allowed for a certain privacy requirement. For example, if there is a romantic context, e.g., a romantic light scene is used by the RF system, e.g., in form of a connected lighting (CL) system in which the nodes are luminaires, then a certain RF sensing configuration which forbids certain sensing applications may be used which inherently is privacy respecting. For instance, the RF system may be allowed for performing RF-based sensing in order to detect occupancy, i.e., occupancy detection, but may not perform RF-based sensing for recognizing breathing rate and/or heart rate, i.e., breathing rate recognition and/or heart rate recognition.

The radio power consumption requirement may include, for example, a standby-power regulatory requirement. A standby-mode may include, for example, not performing a primary function of the node. The node, may be configured, for example, to perform RF-based sensing in the standby mode, i.e., when it is not performing its primary function. For example, the node may be a luminaire, which does not provide light in standby-mode, but performs RF-based sensing. In this case, standby power consumed by the node corresponds to power being consumed by the node while processing RF sensing messages, e.g., including receiving the RF sensing messages, and processing them, e.g., using a sensing analysis algorithm. Power consumption for performing RF-based sensing depends on the setting of the RF system configuration parameters, such that energy consumption may be adjusted in dependence of the RF system configuration parameters such that the radio power consumption requirements may be fulfilled.

The radio transmit power requirement may include, for example, a limitation of transmit power, e.g., due to wireless interference caused by high transmit power. For example, in a hospital room, medical machines may be disturbed by the wireless interference, such that an allowable RF transmit power for performing RF-based sensing may be limited based on the radio transmit power requirement.

The radio beam shape requirement and the radio receive beamforming requirement relate to how beams are required to be shaped which are used for performing RF-based sensing. Beams may be, for example, narrow beams or divergent beams. The beam shape may influence the sensing area that may be covered by performing RF-based sensing. Narrow beams may, for example, allow to cover a longer sensing area, while divergent beams may, for example, allow to cover a wider sensing area. Using a narrow beam may allow to perform RF-based sensing between two nodes which are farther away from each other compared to using a divergent beam. Furthermore, using a narrow beam allows focusing the RF signal into a specific direction, such that beamforming in this manner may allow to provide higher signal quality to the receiving node.

The current location of the at least one of the two nodes may include, for example, a relative location of the at least one of the two nodes to another one of the at least two nodes. This may influence a length of the transmission between the nodes. The current location of the at least one of the at least two nodes may be, for example, in proximity of a tangible entity.

The current location of the tangible entity, e.g., a user, may include a relative location of the tangible entity in or with respect to the sensing area and/or the nodes. In case that the part of the sensing area is not well covered by the group, this may reduce detection performance. For example, the tangible entity may also be a door or a room divider in a room. In case that the tangible entity is a door, its position, e.g. open, closed, or its respective opening angle may affect the RF-based sensing and thus also the detection performance. In case that the tangible entity is a room divider, e.g., in a restaurant dining room, its location may divide the room into two smaller rooms and affect the RF-based sensing and detection performance.

The current date may include a time of the day, e.g., nighttime or daytime, or day of the week, such as a working day or weekend. The RF system may be configured for determining the current date based on a clock and/or calendar.

Requirements, such as standby-power regulatory requirements or radio transmit power requirements may depend, for example, on the current location of the RF system and/or the at least one of the two nodes, and/or on the current date.

A current operation mode of a respective node may include, for example, performing a primary function, such as providing lighting, performing RF-based sensing, and/or operating in standby-mode.

Environmental effects may include, for example, wireless interference, background noise level, or a combination thereof. The environmental effects may be caused, for example, based on humidity in the air, smog, cigarette smoke, activities in areas adjacent to the sensing area, or a combination thereof. Background noise may be caused, for example, by a noise source, such as a microwave oven or a streaming television. The background noise may deteriorate the signal-to-noise ratio (SNR) for the RF-based sensing and increase a number of missed RF messages between the nodes, i.e., reducing a sampling rate or effective messaging rate, respectively.

Taking into account the currently available bandwidth in the RF system may allow to compensate a certain degree of lack of sampling rate, e.g., due to missing RF messages. For example, the RF system configuration parameters may be adapted in order to avoid wireless congestion of the network used by the RF system for exchanging data.

The properties of the sensing area may include, for example, a shape, a regularity, materials, an archetype of a room in which the nodes are arranged or any other property of the sensing area. This allows taking into account the properties of the room for optimizing the detection performance.

The false event detection rate requirement corresponds to a tolerance for false detections. The false event detection rate requirement may include, for example, a false positive rate versus a false negative rate.

The missed event detection requirement corresponds to a tolerance for missing events, i.e., it corresponds to false negative detections. The missed event detection requirement may be, for example, that only a certain rate of events is allowed to be missed, such as 5% of the events.

The RF system may be configured for determining an effect on other sensing applications of adjusting the RF system configuration parameter which affects the detection performance for a certain sensing application the most. The RF system may be configured for adjusting the RF system configuration parameter which affects the detection performance the most based on the effect it has on other sensing applications. This allows to take into account a tradeoff of adjusting the RF system configuration parameter that affects detection performance the most for different sensing applications, e.g., breathing rate recognition vs snappier motion sensing vs fall detection.

The detection performance may include one or more sensing metrics. The sensing metric may include one or more of:
a latency,
an accuracy,
a spatial resolution,
a false positive detection rate,
a false negative detection rate,
a confidence level for detecting a sensing event,
noise in a detection of a sensing event,
a generated data traffic,
an energy consumption, and
a spatial confinement of an RF signal used for performing RF-based sensing.

The RF system may be configured for determining how adjusting the RF system configuration parameter affects the one or more sensing metrics included in the detection performance. The RF system may be configured to not adjust the RF system configuration parameters if one of the sensing metrics is mitigated by adjusting the RF system configuration parameters. Alternatively, the RF system may be configured for determining whether improving one or more of the sensing metrics while mitigating one or more of the other sensing metrics improves the detection performance. The detection performance may be a function of the sensing metrics included in it, e.g., an average, a weighted sum, or the like. Taking into account different sensing metrics of the detection performance may allow a fine grained optimization of the RF system configuration parameters and in particular adjusting the RF system configuration parameter that affects RF-based sensing the most in order to optimize the detection performance.

Noise in the detection of a sensing event may be caused, for example, if the detection comes as a result of a detection signal that swings around a threshold and a sensing event is considered to be detected if the signal is above the threshold. In this case, it does make a difference how much the signal swings above and below the threshold.

The confinement of RF signals depends at least on a frequency used for performing RF-based sensing. For example, 5 GHz WiFi is more confined than 2.4 GHz WiFi. For some sensing applications such as breathing rate recognition at a double bed, it may be beneficial for providing a confined RF signal on one side of the double bed, in particular when two persons are sleeping on the two sides of the double bed.

The RF system may be configured for determining the RF system configuration parameter which affects the detection performance of the RF-based sensing the most based on the one or more sensing metrics included in the detection performance, e.g., based on which of the one or more sensing metrics is included in the detection performance and/or based on one or more sensing metric levels of the sensing metrics. Determining the RF system configuration parameter which affects the detection performance of the RF-based sensing the most based on the one or more sensing metrics included in the detection performance may allow an improved optimization of the detection performance.

A user may provide the one or more sensing metrics of the detection performance, e.g., one or more sensing metrics with which the user is not satisfied. For example, if a user is not satisfied with latency, the user may provide latency as only sensing metric included in the detection performance. The RF system may be configured for determining the RF system configuration parameter which affects latency of the RF-based sensing the most. The RF system may be configured for adjusting the respective RF system configuration parameter in order to optimize the latency. The RF system may be configured for automatically adjusting the RF system configuration parameter which affects the detection performance the most or the user may adjust the RF system configuration parameter which affects the detection performance the most.

The RF system may be configured for determining whether a respective current sensing metric level of the one or more sensing metrics included in the detection performance is above or below a respective threshold sensing metric level. Additionally, the RF system may be configured for determining the RF system configuration parameter which affects the detection performance of the RF-based sensing the most based on which of the respective current sensing metric levels of the one or more sensing metrics included in the detection performance is above or below the respective threshold sensing metric level. Considering threshold sensing metric levels of the sensing metrics may allow easy and fast determination of which sensing metrics perform below expectation e.g., below a minimum viable level or below average. This may allow to derive a root cause that negatively affects the detection performance. Based on the root cause, the RF system configuration parameter which affects the detection performance the most, may be determined easily, e.g., based on rules and/or experience of the RF system. The RF system may be configured for determining the current sensing metric level for each of the one or more sensing metrics included in the detection performance or for a subset of them, e.g., a predetermined subset of sensing metrics of interest for performing RF-based sensing, such as a subset of sensing metrics which affect detection performance the most, e.g., as the sensing metrics have the highest weights, for example, based on rules and/or experience of the RF system.

The RF system may be configured for determining a current detection performance level of RF-based sensing and for optimizing the detection performance based on whether the current detection performance level is above or below a threshold detection performance level. This allows to provide a trigger for optimizing the detection performance, e.g., if the detection performance level is below the threshold detection performance level.

The detection performance may include the one or more sensing metrics. The RF system may be configured for determining whether one or more of the sensing metrics has a respective current sensing metric level below a respective sensing metric threshold level. The RF system may be configured for determining the RF system configuration parameter based on which of the sensing metrics has a respective sensing metric level below the respective sensing metric threshold level. This allows taking into account which sensing metric performs badly in order to determine which RF system configuration parameter allows improving the detection performance.

The RF system may be configured for determining the root cause which negatively affects the detection performance, the RF system configuration parameter which affects the detection performance the most, or both, for example, based on analysing the RF system configuration parameters, the detection performance, a current context, or a combination thereof.

Alternatively, the root cause, the RF system configuration parameter which affects detection performance the most, or both may be provided by a user, e.g., via a communication interface from a server or via direct input in case that the communication interface includes a user interface. This allows triggering by the user, the adjustment of the RF system configuration parameters and in particular of the RF system configuration parameter which affects the detection performance the most in order to optimize the detection performance of RF-based sensing.

In other words, the RF system may be triggered for optimizing the detection performance based on feedback from the user or based on determining automatically whether there is a current sensing metric which is to be optimized. The RF system then may adjust the RF system configuration parameters and in particular the RF system configuration parameter which affects the current sensing metric the most in order to optimize the detection performance. The current sensing metric may need to be optimized, e.g., because of insufficient performance, such as breathing rate recognition frequently losing synchronization with breathing motion. In case of insufficient performance of breathing rate recognition, for example, the RF system may be configured to determine only that a person is present but is not able to determine the breathing rate of the person.

The RF system may be configured for determining a ranking for the one or more RF system configuration parameters ranked according to how much they respectively affect the detection performance of RF-based sensing and for adjusting the RF system configuration parameters based on the ranking in order to optimize the detection performance of RF-based sensing. This may allow to further optimize detection performance since various RF system configuration parameters may be adjusted according to their impact on the detection performance in order to optimize the detection performance. The RF system may be configured for providing a weight to each of the RF system configuration parameters based on their respective ranking. The RF system may be configured for adjusting the RF system configuration parameters serially based on their respective ranking. This may allow to optimize the detection performance faster since the RF system configuration parameters with larger impact on the detection performance are adjusted before RF system configuration parameters with smaller impact on the detection performance are adjusted in order to optimize the detection performance.

The RF system may be configured for providing the RF system configuration parameter which affects the detection performance of the RF-based sensing the most, for providing how the RF system configuration parameter which affects the detection performance of the RF-based sensing the most is to be adjusted for optimizing the detection performance, or a combination thereof. This may allow for improving the detection performance in case that external interaction, e.g., with an external system or user is required, for example, in order to replace, add, or remove one or more of the nodes. The RF system may also be configured for providing the ranking for RF system configuration parameters ranked according to how much they respectively affect the detection performance of RF-based sensing. Additionally, or alternatively, the RF system may be configured for providing how the RF system configuration parameters according to the ranking are to be adjusted for optimizing the detection performance.

The RF system may comprise a communication interface. The communication interface may be configured for providing the RF system configuration parameter which affects the detection performance of the RF-based sensing the most to a user, for providing to the user, how the RF system configuration parameter which affects the detection performance of the RF-based sensing the most is to be adjusted for optimizing the detection performance, or a combination thereof.

The communication interface may include or be a user interface, e.g., a display for displaying the RF system configuration parameter to the user or a touch display additionally allowing the user to provide input, such as information regarding a current context for performing RF-based sensing. Alternatively, the communication interface may include a transceiver and an antenna for transmitting the RF system configuration parameter to a user device or server, such that the user can obtain the RF system configuration parameter from the user device or the server. The user can use the information regarding the RF system configuration parameter in order to optimize detection performance.

In a further aspect of the present invention a method for optimizing detection performance for performing RF-based sensing based on RF system configuration parameters is presented. The method may be a computer implemented method, e.g., a computer implemented method performed on a computer system including a processor and a communication interface, e.g., the RF system. The method comprises the steps:
performing RF-based sensing in a sensing area by a group of at least two nodes of an RF system comprising multiple nodes,
determining an RF system configuration parameter of the RF system configuration parameters which affects detection performance of the RF-based sensing the most, and
adjusting the RF system configuration parameter in order to optimize the detection performance of RF-based sensing.

The method may comprise one or more of the steps:
determining a current context for performing RF-based sensing by the group in the sensing area,
determining the RF system configuration parameter which affects the detection performance of the RF-based sensing the most based on the current context,
determining the RF system configuration parameter which affects the detection performance of the RF-based sensing the most based on one or more sensing metrics included in the detection performance,
determining whether a respective current sensing metric level of the one or more sensing metrics included in the detection performance is above or below a respective threshold sensing metric level,
determining the RF system configuration parameter which affects the detection performance of the RF-based sensing the most based on which of the respective current sensing metric levels of the one or more sensing metrics included in the detection performance is above or below the respective threshold sensing metric level,
determining a current detection performance level of RF-based sensing,
optimizing the detection performance based on whether the current detection performance level is above or below a threshold detection performance level,
determining a ranking for the one or more RF system configuration parameters ranked according to how much they respectively affect the detection performance of RF-based sensing,
adjusting the RF system configuration parameters based on the ranking in order to optimize the detection performance of RF-based sensing,
providing the RF system configuration parameter which affects the detection performance of the RF-based sensing the most,
providing how the RF system configuration parameter which affects the detection performance of the RF-based sensing the most is to be adjusted for optimizing the detection performance,
providing the RF system configuration parameter which affects the detection performance of the RF-based sensing the most to a user, and
providing to the user, how the RF system configuration parameter which affects the detection performance of the RF-based sensing the most is to be adjusted for optimizing the detection performance.

In a further aspect of the present invention a computer program product for optimizing detection performance of RF-based sensing is presented. The computer program product comprises program code means for causing a processor to carry out the method according to claim 12, claim 13, or any embodiment of the method, when the computer program product is run on the processor.

In a further aspect a computer readable medium having stored the computer program product of claim 14 is presented. Alternatively, or additionally, the computer readable medium may have the computer program product according to any embodiment of the computer program product stored.

It shall be understood that the RF system of claim 1, the method of claim 12, the computer program product of claim 14, and the computer readable medium of claim 15 have similar and/or identical preferred embodiments, in particular, as defined in the dependent claims.

It shall be understood that a preferred embodiment of the present invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

In the following drawings:

FIG. 1 shows schematically and exemplarily a node for an RF system,

FIG. 2 shows schematically and exemplarily an embodiment of an RF system with two groups of nodes in a first configuration,

FIG. 3 shows schematically and exemplarily the embodiment of the RF system in a second configuration,

FIG. 4 shows schematically and exemplarily the embodiment of the RF system in a third configuration,

FIG. 5 shows schematically and exemplarily the embodiment of the RF system in a fourth configuration,

FIG. 6 shows schematically and exemplarily the embodiment of the RF system in a fifth configuration, and

FIG. 7 shows an embodiment of a method for optimizing detection performance for performing RF-based sensing.

### DETAILED DESCRIPTION OF EMBODIMENTS

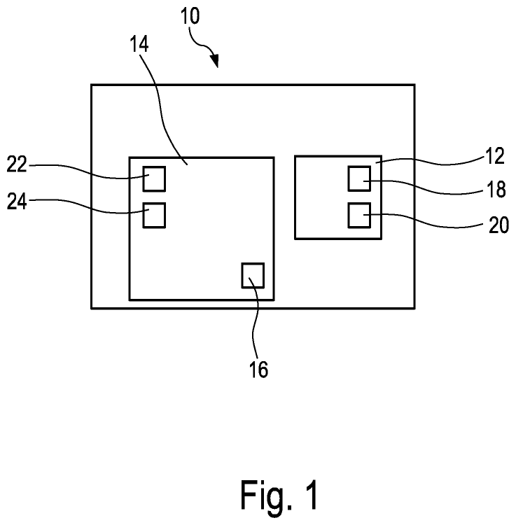

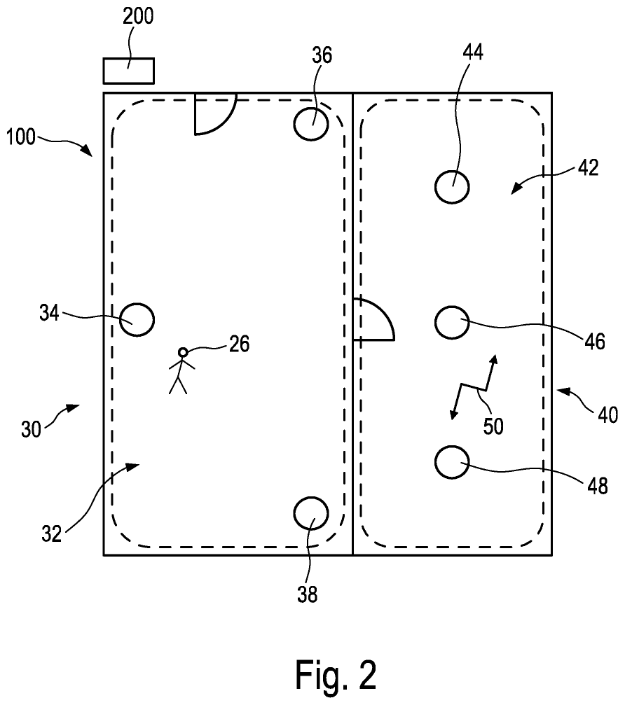

FIG. 1 shows schematically and exemplarily a node for an RF system, e.g., CL system 100 presented in various configurations in FIGS. 2 to 6. In the following we describe details for the exemplary node 10 that may be used in the CL system 100 before providing details about the functionality of the CL systems 100.

The node 10 comprises a control unit 12 and a communication interface 14 including an antenna array 16. Instead of an antenna array, a single antenna may also be included in the node.

The control unit 12 includes a processor 18 and a computer readable medium in form of memory 20.

In this embodiment, the communication interface 14 additionally includes a WiFi transceiver 22 for transmitting and receiving RF signals including RF messages based on WiFi, i.e., WiFi RF messages, as well as a user interface 24 in form of a touch display. In other embodiments, the communication interface may also exchange data based on one or more other communication protocols, such as Thread, cellular radio, Bluetooth, BLE, or any other communication protocol. The communication interface may also include two or more transceivers configured for exchanging data based on different communication protocols.

The communication interface 14 uses the antenna array 16 for transmitting RF signals to nodes and receiving RF signals from nodes of the CL system 100, respectively, for exchanging data including RF messages wirelessly between the nodes and for performing RF-based sensing. The RF signals transmitted from one node to another node may be disturbed, e.g., by a tangible entity such as a user within a transmission path between the nodes. The RF signals disturbed by the user can be analysed in the control unit 12 for performing RF-based sensing.

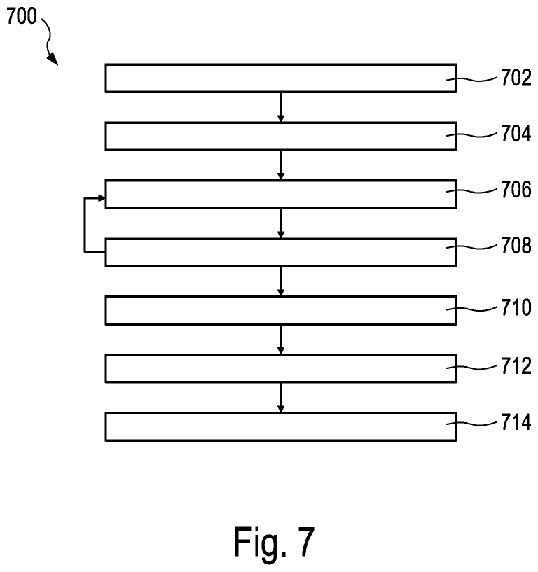

The memory 20 of the control unit 12 stores a computer program product for operating the CL system 100. The computer program product includes program code means for causing processor 18 to carry out a method for optimizing detection performance for performing RF-based sensing, when the computer program product is run on the processor 18, e.g., the method for optimizing detection performance for performing RF-based sensing based on RF system configuration parameters as presented in FIG. 7. The memory 20 further includes a computer program product for operating the node 10 and optionally also the whole CL system 100, respectively, e.g., for controlling the functions of the node and controlling the functions of the nodes of the CL system 100, for example, in order to provide lighting as well as for performing RF-based sensing.

FIG. 2 shows an embodiment of an RF system in form of CL system 100 including a first group 30 of nodes 34, 36, and 38 and a second group 40 of nodes 44, 46, and 48. The CL system 100 is shown in a view from a top perspective in a first configuration arranged in a building with two rooms. The first group 30 performs RF-based sensing in a first sensing area 32 in a first room and the second group 40 performs RF-based sensing in a second sensing area 42 in a second room. In other embodiments, the RF system may have a different number of nodes, e.g., two, three, four, or more and/or a different number of groups. The sensing areas may be of different size, shape and location in the other embodiments. Also in different embodiments, the RF system may be arranged in a different building or in an open space.

Node 34 is a WiFi router and the other nodes 36, 38, 44, 46, and 48 are luminaires for providing light as well as for performing RF-based sensing. In other embodiments, the nodes may also be of another type and perform another function, such as switches, lights, bridges, or the like. The node 34 is wirelessly connected to an external server 200. The external server 200 can be used for controlling the nodes 36 to 48 of the CL system 100, e.g., by transmitting control signals to one or more of them. The external server may be, for example, a server of a building management system (BMS). In this embodiment, the external server 200 only exchanges data directly with node 34. Node 34 then may exchange data with the other nodes 36 to 48 for controlling their functions. Node 34 may also transmit control signals to another node, e.g., node 36 which may forward it to further nodes, such as to nodes 44, 46, and 48.

In this embodiment, locations of the nodes 34, 36, and 38 of the first group 30 define the first sensing area 32 and locations of the nodes 44, 46, and 48 of the second group 40 define the second sensing area 42. In other embodiments or configurations of the CL system 100, sensing areas may be different. The sensing areas may also, for example, be predefined, e.g., adapted to the rooms of a building.

The CL system 100 is used for optimizing detection performance for performing RF-based sensing based on RF system configuration parameters and for performing RF-based sensing with optimized detection performance. In the configuration of the CL system 100 shown in FIG. 2, the CL system 100 optimizes detection performance of the first group 30. The CL system 100 may also optimize the detection performance of the second group 40. In other embodiments, the CL system 100 may optimize a detection performance of the whole CL system 100, e.g., including the detection performances of the first group 30 and the second group 40.

In this embodiment, the detection performance includes various sensing metrics including one or more of: latency, confidence level for detecting a sensing event, an accuracy, a spatial resolution, a false positive detection rate, a false negative detection rate, noise in a detection of a sensing event, a generated data traffic, an energy consumption, and a spatial confinement of an RF signal used for performing RF-based sensing.

The RF system configuration parameters include a spatial arrangement of the nodes 34 to 48 of the respective groups 30 and 40, a grouping of the nodes 34 to 48 into the groups 30 and 40, a number of nodes in the groups 30 and 40, and various sensing parameters for performing RF-based sensing. The sensing parameters include, for example, a transmit power, a sensitivity, a signal strength, a signal link, a beam shape, a directionality of a beam, a threshold level, a type of radio used for performing RF-based sensing, and a communication protocol used for performing RF-based sensing.

Before the CL system 100 optimizes the detection performance, it determines a current detection performance level of RF-based sensing in order to decide, whether it is necessary to optimize it or whether the current detection performance is sufficient. This step is optional.

In this embodiment, the processing is performed by node 34. In other embodiments, processing may also be performed by other nodes of the RF system or on the external server. In order to determine the current detection performance level of the first group 30, the CL system 100 performs RF-based sensing in the sensing area 32 using current RF system configuration parameters. In this embodiment, the CL system 100 only optimizes the detection performance if the current detection performance level is below a threshold detection performance level. In other embodiments, the RF system may be configured for optimizing the detection performance based on whether the current detection performance level is above or below the threshold detection performance level. If the CL system 100 decides that no optimization of the detection performance is necessary, the CL system 100 performs RF-based sensing using the current RF system configuration parameters. Else, the CL system 100 optimizes the detection performance.

In order to optimize the detection performance, the CL system 100 determines which RF system configuration parameter affects the detection performance the most based on a current context and based on the sensing metric levels of the sensing metrics included in the detection performance. In other embodiments, the RF system may be configured, for example, for determining the RF system configuration parameter which affects the detection performance the most based on which of the one or more sensing metrics is included in the detection performance, alternatively or additionally to their sensing metric levels.

In this embodiment, the current context includes sensing applications performed by the first group and an environmental effect in form of wireless interference 50 caused in the first sensing area 32 by operating the second group 40. The sensing applications are determined by an input provided by a user 26, i.e., the user 26 decides which sensing applications are to be performed by the CL system 100. In this embodiment, the CL system 100 is used for occupancy detection. The wireless interference 50 is determined based on a sensing analysis algorithm which detects wireless interference based on RF signals including RF messages exchanged between the nodes, namely in dependence of signal strength as well as of missed RF message rates.

In other embodiments, the current context may also include, for example, a setting of one or more of the RF system configuration parameters, a latency requirement, an expected sensing event in the sensing area, a privacy requirement, a radio power consumption requirement, a radio transmit power requirement, a radio beam shape requirement, a radio receive beamforming requirement, a current location of the RF system, a current location of at least one of the at least two nodes, a current location of a tangible entity in the sensing area, a current date, a current operation mode of at least one of the at least two nodes, currently available bandwidth in the RF system, current capabilities of the at least one of the at least two nodes, current properties of the sensing area, a false event detection rate requirement, and a missed event detection requirement.

The CL system 100 determines whether a respective current sensing metric level of the sensing metrics included in the detection performance is above or below a respective threshold sensing metric level, e.g., whether a current latency level is above or below a threshold latency level of, e.g., 0.2 s. In this embodiment, the user provides a current latency level of, e.g., 0.5 s to the CL system 100. The current latency level is thus above the threshold latency level. In other embodiments, the current sensing metric level may also be determined automatically, e.g., if a current energy consumption level is above a threshold energy consumption level.

The RF system configuration parameter which affects the detection performance of the RF-based sensing the most is then determined based on which of the respective current sensing metric levels of the one or more sensing metrics included in the detection performance is above or below the respective threshold sensing metric level. For example, if the current latency level is above the threshold latency level, the performance of the latency is considered to be suboptimal. This is considered when determining the root cause for the negatively affected detection performance. The CL system 100 may include a database, such as a look-up-table (LUT) in which RF system configuration parameters which affect detection performance the most are associated to combinations of suboptimal performances of sensing metrics. In other embodiments, root causes may be stored instead of RF system configuration parameters and the RF system configuration parameters may be associated to the root causes. The LUT may be provided based on experience, e.g., learned by trial-and-error or heuristics based.

After the CL system 100 determined which RF system configuration parameter affects the detection performance the most, the CL system 100 adjusts this RF system configuration parameter in order to optimize the detection performance. In this embodiment, the CL system 100 performs simulations on how to adjust the RF system configuration parameter by simulating its adjustment and determining the impact on the detection performance. Alternatively, or additionally, the CL system 100 may also determine how to adjust the RF system configuration parameter based on rules, e.g., rules stored in the memory of one of the nodes, such as, adjusting a certain RF system configuration parameter in a certain manner based on a current context. In other embodiments, adjusting the RF system configuration parameter which affects the detection performance the most may also be performed by iteratively adjusting the respective RF system configuration parameter of the CL system 100 and comparing the previous detection performance with the subsequent detection performance obtained by performing RF-based sensing using the respective adjusted RF system configuration parameter. The adjustment may be performed automatically by the CL system 100 and/or a user 26 may be instructed to adjust the RF system configuration parameter, e.g., depending on which RF system configuration parameter is to be adjusted.

Therefore, the CL system 100 may use the communication interface of node 34 for providing to the user 26, the RF system configuration parameter which affects the detection performance of the RF-based sensing the most, and how the RF system configuration parameter which affects the detection performance of the RF-based sensing the most is to be adjusted for optimizing the detection performance. The user 26 may, for example, receive this information via the touch display 24 or via a user device, such as a mobile phone (not shown). The user 26 may then adjust the RF system configuration parameter which affects the detection performance the most accordingly in order to optimize the detection performance.

In other embodiments, further RF system configuration parameters may be adjusted for optimizing the detection performance after optimizing the detection performance with respect to the RF system configuration parameter which affects the detection performance the most. In other embodiments, for example, in case that adjusting the RF system configuration parameter which affects the detection performance the most does not sufficiently improve the detection performance, the CL system 100 may determine a ranking for the RF system configuration parameters ranked according to how much they respectively affect the detection performance. The CL system 100 may then adjust the RF system configuration parameters according to their rank in order to optimize the detection performance, i.e., the RF system configuration parameters may be adjusted serially one after the other until the detection performance is sufficiently improved, e.g., when a current detection performance level is above a threshold detection performance level. The adjustment of the RF system configuration parameters may also take into account if several of the RF system configuration parameters are interdependent and iteratively adjust these RF system configuration parameters according to one of the techniques known to the skilled person from the prior art.

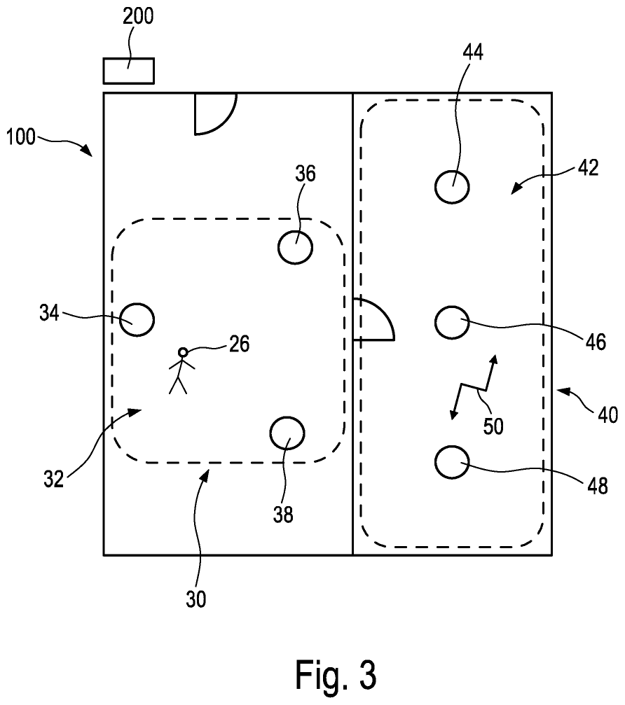

FIG. 3 to FIG. 6 show various configurations of the CL system 100 based on different adjustments to the CL system 100 in order to optimize detection performance of RF-based sensing for different contexts.

In FIG. 3, a second configuration of the CL system 100 is shown in which nodes 36 and 38 of the first group 30 are moved in the horizontal plane with respect to the first room in order to bring them closer to each other. This allows compensating a low RF signal strength. In this embodiment, the sensing area 32 is also adjusted. The other nodes 34, 44, 46, and 48 are not moved.

In the following, details are presented, how the CL system 100 determined that moving the nodes 36 and 38 allows optimizing detection performance in the context of FIG. 3.

The CL system 100 first determines how much adjusting sensitivity of the nodes 34, 36, and 38 affects the detection performance and finds that it does not significantly affect the detection performance. The CL system 100 then checks the effect of wireless interference 50 in the signal links between the nodes 34, 36, and 38 on the detection performance. In this case, the effect of wireless interference 50 is negligible. The CL system 100 subsequently determines how much other RF system configuration parameters affect the detection performance in order to find a root cause for the negatively affected detection performance. The CL system 100 finds, that a signal link between two nodes, e.g., 36 and 38 has only a low RF signal strength. A low RF signal strength may result in lower detection performance as RF messages are more likely to be affected by even small environmental effects thus that they are potentially not received.

Based on the knowledge that the low RF signal strength between the nodes 36 and 38 is the root cause of the poor detection performance of RF-based sensing, the CL system 100 determines how to optimize the detection performance. Therefore, the CL system 100 uses an optimization approach based on previous experience, namely, that adding a further new node does not necessarily improve the detection performance as this would not improve the RF signal strength and thus the signal link between nodes 36 and 38. Thus, the CL system 100 determines that moving the nodes 36 and node 38 closer to each other improves the detection performance as the RF path between them is stronger. Alternatively, the CL system 100 may simulate several slightly modified positions of node 36 and 38 in order to identify a spatial arrangement of the nodes 36 and 38 where multi-path effects become more dominant and allow increasing the RF signal strength of the signal link between nodes 36 and 38.

Alternatively, locations of the nodes may also be adjusted by moving them in the vertical plane, i.e., in vertical direction instead of the horizontal plane, i.e., the horizontal direction. For example, a node in form of a standing luminaire may have an adjustable stand for adjusting a vertical location of the antenna array of the node that transmits and receives the RF signals and a node in form of a pendant may have an adjustable chain or wire for adjusting the vertical location of its antenna array. The CL system 100 may determine that adjusting the vertical location affects detection performance the most, e.g., based on metadata like an archetype of the luminaire, or based on direct measurement information, obtained for example, based on augmented reality (AR) measurement tools, light detection and ranging (LiDAR), laser distance measurements, etc.

The CL system 100 may also determine that a vertical location of a node may be adjusted rather than moving the node in horizontal direction if moving the node in horizontal direction is limited. Some locations of nodes may not be useable, e.g., some horizontal locations and/or vertical locations may not be accessible by the node. Adjusting vertical and/or horizontal location of a node increases the amount of useable locations. For example, ceiling luminaires may have limited options on where they can be placed horizontally but may be adjusted in vertical direction more freely. This may allow an improved automatic or manual adjusting of the location of a node.

Alternatively, user 26 may provide information regarding the root cause or current context for performing RF-based sensing to the CL system 100. This information may be used for determining which RF system configuration parameter affects detection performance the most and how to adjust this RF system configuration parameter in order to optimize the detection performance.

For example, the user 26 may indicate that RF-based sensing does not perform well in proximity of certain objects (not shown) or does not work at a certain time of the day, e.g. in the evening, or often does not work during certain activities, e.g., another user in the adjacent room streaming videos via the internet, or the RF-based sensing does not work in parts of the first room, such as occupancy detection failing when the user is working on a desk or breathing rate recognition failing when a user lies on a left side of a double bed but not on the right side.

For these contexts, the CL system 100 may combine the information provided by the user with further current context, e.g., determined by the CL system 100, such as a current setting of the RF system configuration parameters. Furthermore, for example, the CL system 100 may determine for the RF system configuration parameters how much they respectively affect the detection performance taking into account the current context.

The user 26 may also, for example, provide information on whether a certain RF system configuration parameter is adjustable. For example, if a node in form of a luminaire spotlight with a rotating head is included in the CL system 100, a directionality of an RF pattern may be changed by aiming the spotlight at a different angle. In contrast, such RF system configuration parameter may not be adjustable for a node in form of a hanging luminaire, for example.

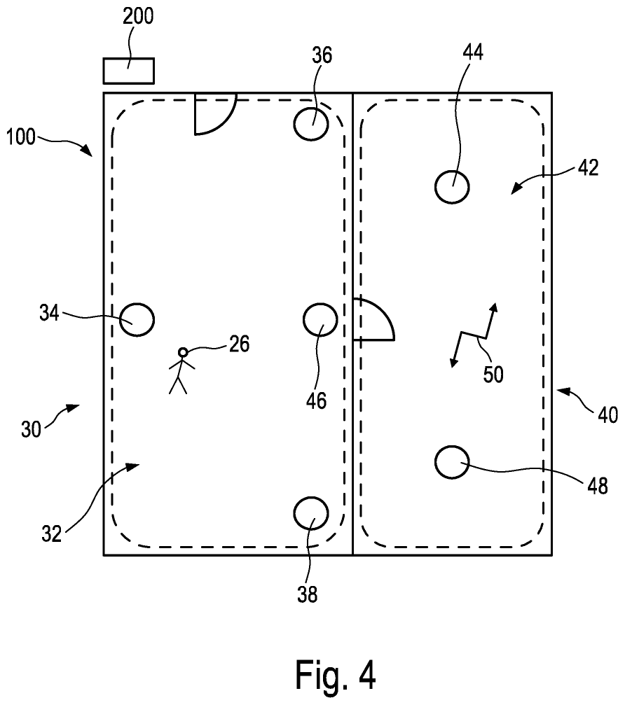

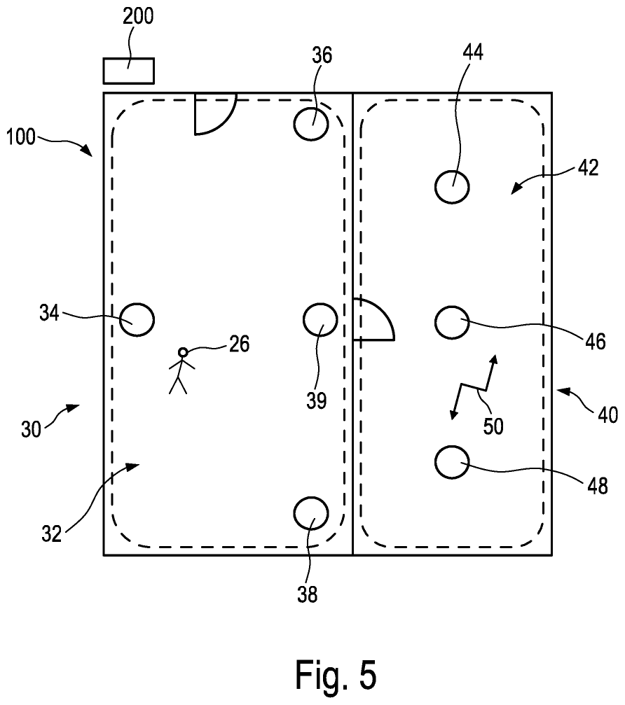

If the user 26 inputs an option to the CL system 100 to add a new node to the first group 30, either by adding a node to the first group 30, e.g. node 46 from the second group 40 (cf. FIG. 4), or adding a new node 39 to the CL system 100 (cf FIG. 5), the CL system 100 may determine how this adjustment affects the detection performance and which spatial location of the newly added node optimizes the detection performance.

For example, the CL system 100 may determine that adding the new node as close as possible to the desk on which the user is working optimizes the detection performance. Alternatively, the CL system 100 may also optimize the detection performance based on further current context, e.g., based on analyzing signal links among all nodes in the sensing area and focusing on those signal links that allow to provide specific metadata that may infer that the node is close to a location of the desk at which the user is working, i.e., the location which needs improved RF-based sensing. The node close to the location of the desk may be, for example, a reading light type or have a name like “Desktop Left”, etc. This may result in finding that non-trivial RF system configuration parameters, such as a new node in form of a ceiling light at a location in the center of the room affects detection performance the most. Such a ceiling light may provide signal links that go through the volume of the area in which the desk is located and therefore may allow improving coverage of RF-based sensing at the desk and thus to optimize detection performance.

In case that adding a node is not possible or acceptable, the CL system 100 may provide an alternative RF system configuration parameter and information on how to adjust it to the user. This alternative RF system configuration parameter may be, for example, one that does not compromise other signal links that already exist. For example, the CL system 100 may find that the RF system configuration parameter or RF system configuration parameters that may be adjusted for optimizing the detection performance is a respective location or are locations of nodes who have a strongest signal link with respect to other nodes. For theses nodes minor movements do not significantly disrupt the quality of those signal links and lead to missed RF messages which would result in disrupted RF-based sensing. Therefore, the location of theses nodes may be adjusted to bring them closer to the desk, e.g., shifting the sensing area and its coverage.

Moving the locations of the nodes on the other hand may negatively affect other parts of the sensing area or other sensing applications. The CL system 100 may be configured for taking this into account when optimizing the detection performance. For example, nodes which in the original configuration have an acceptable performance but are close to a quality threshold of being considered noisy may further degrade by putting emphasis on improving RF-based sensing close to the desk. This may result in optimized detection performance at the desk but reduce detection performance in another part of the sensing area, e.g., close to a door. The CL system 100 may furthermore consider, which of the parts of the sensing area are areas of interest and optimize detection performance such that detection in or close to the areas of interest is optimized.

In FIG. 4, a third configuration of the CL system 100 is shown in which node 46 is removed from the second group 40 and added to the first group 30. This allows improving the detection performance of the first group 30 while it may diminish the detection performance of the second group 40. In this case the node 46 is not only regrouped from the second group 40 to the first group 30, but spatially moved.

Alternatively, the CL system 100 may also regroup the first group 30 and the second group 40 by removing the node 46 from the second group 40 and adding it to the first group 30 without adjusting the spatial location, i.e., without moving, the node 46. This may also allow to optimize detection performance.

The CL system 100 may determine whether node 46 is critical for the sensing application of the second group 40 before removing it and adding it to the first group 30. The CL system 100 may decide whether to remove the node 46 from the second group 40 and add the node 46 to the first group 30 based on whether it is critical for the sensing application of the second group 40. This may allow to avoid diminishing the detection performance in the second sensing area 42 significantly.

For example, the CL system 100 may determine based on, for example, generic ZigBee neighbour tables, that the node 46 is arranged in an adjacent sensing area 42 to the first group 30 which has strong signal links to the nodes 36 and 38. The CL system 100 may then determine that adding the node 46 to the first group 30 may be the RF system configuration parameter to be adjusted that affects detection performance the most. Before adjusting the RF system configuration parameter by adding the node 46 to the first group 30, the CL system 100 may check whether this adjustment diminishes the detection performance of the second group 40 and/or whether and how detection performance is optimized in the first sensing area 32. The CL system 100 may alternatively or additionally, determine how adding the node 46 to the first group 30 affects operation of the second group 40, e.g., whether detection performance is diminished in the second sensing area 42 or whether, for example, false positive rate for performing RF-based sensing in the first sensing area 32 is increased due to activity in the second sensing area 42, in which the node 46 is still located as it was not moved.

Yet alternatively, the node 46 may also be included in both groups 30 and 40 and perform RF-based sensing in both sensing areas 32 and 42. In this case, the CL system 100 may, for example, adjust or suggest to the user to adjust one or more sensing parameters for performing RF-based sensing of both groups 30 and 40. The CL system 100 may also adjust or suggest to the user to adjust other RF system configuration parameters than the sensing parameters. For example, the user may be instructed to move another node of the second group 40 to a new location for compensating for a lack of resolution or reliability for performing RF-based sensing in the first sensing area 32 or the second sensing area 42. In FIG. 5, a fourth configuration of the CL system 100 is presented in which a node 39 is added to the first group 30 for mitigating the wireless interference 50. The wireless interference 50 is caused by operation of the second group 40 in this configuration. Environmental effects may also include, for example, RF noise provided by any other noise source, such as a microwave oven or a video streaming television.

The first group 30 is arranged in a hallway and the user 26 has spent some time configuring the nodes 34, 36, and 38 of the first group 30 for performing RF-based sensing in the hallway to ensure a satisfactory balance between fast motion detections and avoiding false positives in the adjacent living room which includes the second group 40. If the detection performance is not satisfactory, the user 26 may report his dissatisfaction, for example, to the CL system 100 via the communication interface of node 34, e.g., using an app on a user device and transmit this information to node 34 or using any other available user interface, such as a touch display.

In response the CL system 100 first, examines the impact of all RF system configuration parameters on the detection performance. Then the CL system 100 determines that the root cause for the negatively affected detection performance are the signal links between the nodes 34, 36, and 38 which are too noisy, i.e., in this case received signal strength indication (RSSI) or channel state information (CSI) fluctuate too much, e.g., above a threshold value. Subsequently the CL system 100 determines that the best solution for mitigating the root cause of the negatively affected detection performance, namely, the noisy signal links between the nodes 34, 36, and 38 is to add a further node to the group 30. The CL system 100 understood that adding data from further signal links will enable the sensing analysis algorithm to further correlate what is already observed by the original signal links, but with higher confidence. This allows to detect sensing events with higher confidence.

For instance, the RF system may determine that any signal links with, e.g., an amplitude fluctuation exceeding 20% of historical values, e.g., an historical average value determined for a certain time window, is considered as noisy. Alternatively, the RF system may also measure a frequency of amplitude peaks and determine that a signal link is presently extraordinarily noisy based on the frequency of amplitude peaks.

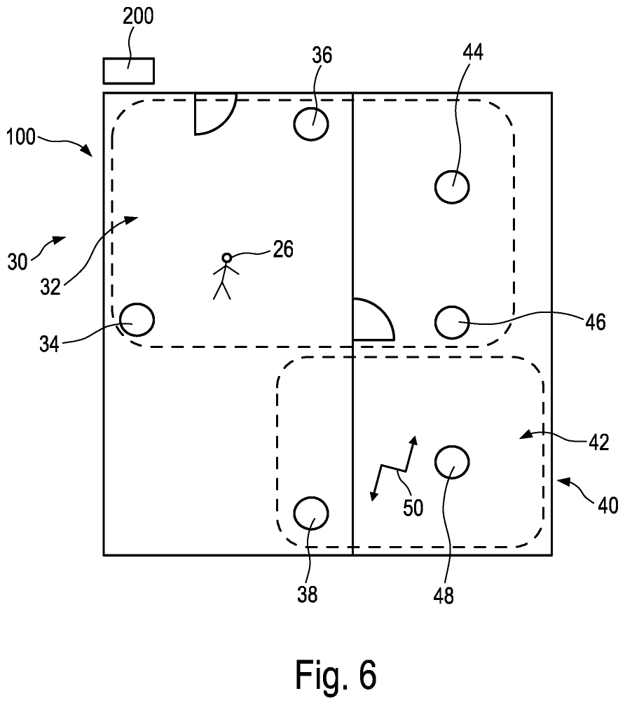

In FIG. 6, a fifth configuration of the CL system 100 is shown in which the nodes 34, 36, 44, and 46 are regrouped into the first group 30 and the groups 38 and 48 are regrouped into the second group 40. This also adjusts the sensing areas 32 and 42. Regrouping the nodes 34 to 48 may allow to optimize the detection performance based on a current context, e.g., if adjusting the sensing areas improves detection performance, for example, as a sensing event occurs in a part of a sensing area which is not well covered and adjusting the sensing area optimizes coverage. In other cases, the nodes may additionally be moved.

Further scenarios, i.e., the CL system 100 operating in different current contexts are presented in the following without figures.

The CL system 100 may not only determine a node which when moved affects detection performance the most, but also how moving this node affects other sensing applications. For example, if a specific sensing metric is to be optimized for a specific sensing application, e.g., latency for detecting occupancy for a user entering a sensing area, this may affect other sensing applications, such as breathing rate recognition of the breathing rate of a first of two users lying in a double bed.

For example, if a bedroom has two nodes in form of free-floor-standing night lights and a ceiling light, this configuration may not be sufficient for achieving a sufficiently low latency in turning the lights on when a user enters the room. The CL system 100 may determine that due to the size of the bed room, the type of the room being a bed room, etc. that moving one of the free-floor-standing night lights 30 cm closer to an entrance of the room allows optimizing the detection performance. In this case it is simulated and may be confirmed afterwards by performing RF-based sensing to check the simulation, that this adjustment of the position of the free-floor-standing night light reduces the latency while not significantly degrading a signal link between the nodes.

However, moving one of the free-floor-standing night lights by 30 cm may significantly affect detection performance for breathing rate recognition of the first user lying on a first side of the double bed when a second user is lying on a second side of the double bed. For instance, as 2.4 GHz or 5 GHz WiFi signals show low confinement, i.e., they do not have sharp cut-offs, after the free-floor-standing night light is moved by 30 cm, the RF signals may now not only interact with the first user but also with the second user lying on the second side of the double bed. Hence moving the free-floor-standing night light by 30 cm may greatly disturb the RF sensing analysis algorithm for breathing rate recognition.

In this case, the CL system 100 may defer from moving the free-floor-standing night light by 30 cm and instead determine to adjust an alternative RF system configuration parameter, e.g., the RF system configuration parameter which affects the detection performance of the occupancy detection the most while not significantly diminishing or even improving the detection performance of the breathing rate recognition. For example, a new node may be added to the group closer to the entrance of the room for performing RF-based sensing in the sensing area. Alternatively, for example, the messaging rate may be increased.

Yet alternatively, the CL system 100 may also determine that moving the free-floor-standing night light in the horizontal plane or adjusting its height may be preferred over adding a new node. Adding a new node may increase the resources needed by each of the nodes of the group performing RF-based sensing since, for example, more nodes need to be kept track of and amount of data traffic between the nodes is increased. Hence, adding a new node may be counterproductive to the detection performance as, for example, data traffic, wireless interference, and energy consumption are increased.

The CL system 100 may therefore determine whether the detection performance is improved by improving one sensing metric while another sensing metric is diminished, e.g. increasing data traffic. The CL system 100 may, for instance, determine that data traffic in the sensing area already is close to, e.g., a network clogging threshold for successful message reception. Adding yet another new node to the group performing RF-based sensing in the sensing area would therefore further degrade this already weak sensing metric and may even result in the data traffic exceeding the network clogging threshold such that RF messages will be missed. Based on this current context, the CL system 100 may determine that adjusting another RF system configuration parameter than adding a new node or increasing messaging rate is preferable, e.g., moving the free-floor-standing night light in the horizontal plane or vertical plane.

In summary, the RF system may automatically improve or provide feedback to a user for improving detection performance in a specific sensing area. The RF system can identify a root cause for a negatively affected detection performance because of which the user perceives the RF-based sensing as being suboptimal. Based upon the root cause the RF system can provide suggestions for improving the detection performance, namely by adjusting one or more RF system configuration parameters and in particular the RF system configuration parameter which affects the detection performance the most. The suggestions for improving the detection performance may take also into account the current context including, for example, sensing applications or desired sensing functionalities, respectively, ranked by priority, a predominant activity type in the sensing area, a tolerance for false detection, a latency requirement, latency expectations, or any other context. For example, different context causes the RF system for adjusting or for suggesting which RF system configuration parameter or RF system configuration parameters should be adjusted by, e.g., adding a node or changing a spatial location of an existing node. The current context may also allow to decide how the RF system consciously trades off between performances of different sensing metrics concurrently served by the same RF system, e.g., breathing detection vs snappier motion sensing in the sensing area vs fall detection in an adjacent sensing area, in order to improve detection performance including the performances of the different sensing metrics.

The overall goal of the RF system is to improve detection performance, e.g., by providing the user more relevant suggestions or options for adjusting the RF system configuration parameters beyond prior art's simply adjusting sensitivity levels. The adjusting of the RF system configuration parameters allows a finetuning of the RF-based sensing in a highly context-aware, and in particular sensing application-aware manner.

The RF system may allow guiding a user for optimizing the detection performance, in particular in case that the user does not know the root cause for diminished detection performance and/or how to optimize the detection performance. The RF system may guide the user in response to information provided by the user about the current context as well as information regarding the current context obtained by the RF system itself. For example, the user may indicate that latency is too high, i.e., RF-based sensing takes too long, whenever the user enters the sensing area from a front door but not when the user enters from another door. In this case, the user may provide a current context to the RF system why the detection performance is insufficient without himself knowing the root cause for the diminished detection performance, e.g., too many or too few nodes performing RF-based sensing, an insufficient sampling rate, too low transmission power, or the like. Combining the information regarding the current context provided by the user with the information regarding the current context of the RF system, however, may allow to find the root cause and subsequently to determine how to optimize the detection performance.

FIG. 7 shows an embodiment of the method 700 for optimizing detection performance for performing RF-based sensing based on RF system configuration parameters. The method may be performed, for example, by an RF system, such as the CL system 100 presented with respect to FIG. 2 to FIG. 6.

In step 702, a user provides information regarding a current context for performing RF-based sensing in a sensing area by a group of nodes and a sensing metric with which the user is not satisfied. For example, the user provides that the RF system is used for occupancy detection and that a latency requirement of 0.2 s is provided for the detection to be finished in order to allow a fast reaction of the RF system, e.g., turning on lighting when a user enters the sensing area. The user may furthermore provide that he is not satisfied with the latency, e.g., since the latency is above 0.2 s, for example, at 0.4 s.

In step 704, a current context for performing RF-based sensing in the sensing area by the group is determined based on the information provided by the user as well as on information obtained by the nodes such as a current setting of RF system configuration parameters including a current spatial arrangement of the nodes, as well as a number of nodes in the group for performing RF-based sensing in the sensing area. The information provided by the user and obtained by the nodes are analysed.

In step 706, RF-based sensing is performed in a sensing area by a group of nodes of the RF system.

In step 708, a current detection performance level of RF-based sensing is determined based on the performed RF-based sensing. In this case, the current detection performance level depends on the current latency for detecting occupancy. If the detection performance level is above a threshold detection performance level, the current RF system configuration parameters are used for performing RF-based sensing in the sensing area, i.e., step 706 is performed as long as the current detection performance level of RF-based sensing is above the threshold detection performance level. If the current detection performance level is below the threshold detection performance level, step 710 is performed in order to optimize the detection performance of RF-based sensing. In this case, the latency is higher than the latency requirement of 0.2 s and the resulting current detection performance level is below the threshold detection performance level, such that step 710 is performed.

In step 710, an RF system configuration parameter of the RF system configuration parameters which affects detection performance of the RF-based sensing the most is determined based on the current context and current sensing metric levels of sensing metrics included in the detection performance. Therefore, it is determined whether a respective current sensing metric level of the sensing metrics included in the detection performance is below a respective threshold sensing metric level. In this case, it is determined that the latency is above the latency requirement which corresponds to the sensing metric level being below the threshold sensing metric level. In response, the RF system configuration parameters which affect the respective sensing metrics with a sensing metric level below the respective threshold sensing metric level are determined from an LUT which includes information associated which RF system configuration parameter affects which sensing metric the most. In this case, latency is generated due to limited processing capabilities of the nodes in the group.

In step 712, an information which RF system configuration parameter affects the detection performance of the RF-based sensing the most is provided to a user. In this case, an information is provided to the user that capabilities of the nodes in the group affect detection performance the most as the processing capability of the nodes is too low to perform RF-based sensing with a lower latency.

Additionally, the user is provided with an information how the RF system configuration parameter which affects the detection performance of the RF-based sensing the most is to be adjusted for optimizing the detection performance. In this case, the user is provided with the information that a node with a lower processing power may be replaced by a node with a higher processing power or a node with higher processing power may be added to the group. In other embodiments, these information may be provided to the nodes of the RF system that optimize the RF system configuration parameter which affects the detection performance the most. For example, if a transmit power is the RF system configuration parameter which affects the detection performance the most, the respective node or nodes may adjust their transmit powers in order to optimize the detection performance.

In step 714, the RF system configuration parameter which affects detection performance of the RF-based sensing the most is adjusted by the user in order to optimize the detection performance of RF-based sensing. In this case, an additional node with higher processing power is added to the group in order to lower the latency.

In other embodiments, the nodes of the RF system may automatically adjust the RF system configuration parameter which affects detection performance of the RF-based sensing the most based on the information how the RF system configuration parameter which affects the detection performance the most is to be adjusted for optimizing the detection performance, e.g., increasing transmit power.

In other embodiments, a ranking for the one or more RF system configuration parameters ranked according to how much they respectively affect the detection performance of RF-based sensing may be determined and the RF system configuration parameters may be adjusted based on the ranking in order to optimize the detection performance of RF-based sensing.

While the invention has been illustrated and described in detail in the drawings and foregoing description, such illustration and description are to be considered illustrative or exemplary and not restrictive; the invention is not limited to the disclosed embodiments. For example, it is possible to operate the invention in an embodiment wherein the RF system is a heating ventilation air-conditioning (HVAC) system or any other smart home system. The RF system may also be operated in the context of a BMS environment, a smart home environment, an office environment, or a residential environment.

Other variations to the disclosed embodiments can be understood and effected by those skilled in the art in practicing the claimed invention, from a study of the drawings, the disclosure, and the appended claims.

In the claims, the word “comprising” and “including” does not exclude other elements or steps, and the indefinite article “a” or “an” does not exclude a plurality.

A single unit, processor, or device may fulfill the functions of several items recited in the claims. The mere fact that certain measures are recited in mutually different dependent claims does not indicate that a combination of these measures cannot be used to advantage.

Operations like performing RF-based sensing in a sensing area by a group of at least two nodes of an RF system comprising multiple nodes, determining an RF system configuration parameter of the one or more RF system configuration parameters which affects detection performance of the RF-based sensing the most, adjusting the RF system configuration parameter which affects the detection performance the most in order to optimize the detection performance of RF-based sensing, et cetera performed by one or several units or devices can be performed by any other number of units or devices. These operations and/or the method can be implemented as program code means of a computer program and/or as dedicated hardware.

A computer program product may be stored/distributed on a suitable medium, such as an optical storage medium, or a solid-state medium, supplied together with or as part of other hardware, but may also be distributed in other forms, such as via the Internet, Ethernet, or other wired or wireless telecommunication systems.

Any reference signs in the claims should not be construed as limiting the scope.

The present invention relates to an RF system with multiple nodes and a method for optimizing detection performance for performing RF-based sensing in a sensing area based on RF system configuration parameters. An RF system configuration parameter of the RF system configuration parameters which affects detection performance of the RF-based sensing the most is determined. The RF system configuration parameter which affects detection performance of the RF-based sensing the most is then adjusted in order to optimize the detection performance of RF-based sensing. A root cause for a diminished detection performance and the respective RF system configuration parameter for mitigating it may be determined based on current context. For optimizing the detection performance, for example, settings of sensing parameters of the nodes may be adjusted or the nodes may be moved, removed, added, or replaced.

1. A radio frequency system for optimizing detection performance for performing radio frequency based sensing based on radio frequency system configuration parameters, the radio frequency system comprising multiple nodes of which a group of at least two nodes is configured for performing radio frequency based sensing in a sensing area, wherein a first node of the at least two nodes is configured for transmitting radio frequency signals and a second node of the at least two nodes is configured for receiving the transmitted radio frequency signals, and wherein the radio frequency based sensing is performed by analysing disturbances to the radio frequency signals caused by interaction of the radio frequency signals with one or more objects or persons on their transmission paths between the at least two nodes,
wherein the radio frequency system is configured for determining a radio frequency system configuration parameter of the radio frequency system configuration parameters which has a larger effect on the detection performance of the radio frequency based sensing than a corresponding adjustment to another radio frequency system configuration parameter and for adjusting the radio frequency system configuration parameter which has a larger effect on the detection performance of the radio frequency based sensing than a corresponding adjustment to another radio frequency system configuration parameter in order to optimize the detection performance of radio frequency based sensing.

2. The radio frequency system according to claim 1, wherein the radio frequency system configuration parameters include one or more of:
a spatial arrangement of the at least two nodes of the group,
a grouping of the multiple nodes into the group,
a number of nodes, in the group,
capabilities of the nodes in the group, and
one or more sensing parameters for performing radio frequency based sensing.

3. The radio frequency system according to claim 1, wherein the radio frequency system is configured for determining the radio frequency system configuration parameter which affects the detection performance of the radio frequency based sensing the most based on a current context.

4. The radio frequency system according to claim 3, wherein the current context includes one or more of:
a setting of one or more of the radio frequency system configuration parameters,
a sensing application,
a latency requirement,
an expected sensing event in the sensing area,
a privacy requirement,
a radio power consumption requirement,
a radio transmit power requirement,
a radio beam shape requirement,
a radio receive beamforming requirement,
a current location of the radio frequency system,
a current location of at least one of the at least two nodes,
a current location of a tangible entity in the sensing area,
a current date,
a current operation mode of at least one of the at least two nodes,
environmental effects,
currently available bandwidth in the radio frequency system,
current capabilities of the at least one of the at least two nodes,
current properties of the sensing area,
a false event detection rate requirement, and
a missed event detection requirement.

5. The radio frequency system according to claim 1, wherein the detection performance includes one or more sensing metrics including one or more of:
a latency,
an accuracy,
a spatial resolution,
a false positive detection rate,
a false negative detection rate,
a confidence level for detecting a sensing event,
noise in a detection of a sensing event,
a generated data traffic,
an energy consumption, and
a spatial confinement of a radio frequency signal used for performing radio frequency based sensing.

6. The radio frequency system according to claim 5, wherein the radio frequency system is configured for determining the radio frequency system configuration parameter which affects the detection performance of the radio frequency based sensing the most based on the one or more sensing metrics included in the detection performance.

7. The radio frequency system according to claim 5, wherein the radio frequency system is configured for
determining whether a respective current sensing metric level of the one or more sensing metrics included in the detection performance is above or below a respective threshold sensing metric level, and
determining the radio frequency system configuration parameter which affects the detection performance of the radio frequency based sensing the most based on which of the respective current sensing metric levels of the one or more sensing metrics included in the detection performance is above or below the respective threshold sensing metric level.

8. The radio frequency system according to claim 1, wherein the radio frequency system is configured for
determining a current detection performance level of radio frequency based sensing, and
optimizing the detection performance based on whether the current detection performance level is above or below a threshold detection performance level.

9. The radio frequency system according to claim 1, wherein the radio frequency system is configured for
determining a ranking for the one or more radio frequency system configuration parameters ranked according to how much they respectively affect the detection performance of radio frequency based sensing, and
adjusting the radio frequency system configuration parameters based on the ranking in order to optimize the detection performance of radio frequency based sensing.

10. The radio frequency system according to claim 1, wherein the radio frequency system is configured for one or both of:
providing the radio frequency system configuration parameter which has a larger effect on detection performance of the radio frequency based sensing than a corresponding adjustment to another radio frequency system configuration parameter, and
providing how the radio frequency system configuration parameter which has a larger effects on the detection performance of the radio frequency based sensing than a corresponding adjustment to another radio frequency system configuration parameter is to be adjusted for optimizing the detection performance.

11. The radio frequency system according to claim 10, wherein the radio frequency system comprises a communication interface for one or both of:
providing the radio frequency system configuration parameter which has a larger effect on the detection performance of the radio frequency based sensing than a corresponding adjustment to another radio frequency system configuration parameter to a user, and
providing to the user, how the radio frequency system configuration parameter which has a larger effect on the detection performance of the radio frequency based sensing than a corresponding adjustment to another radio frequency system configuration parameter is to be adjusted for optimizing the detection performance.

12. A method for optimizing detection performance for performing radio frequency based sensing based on radio frequency system configuration parameters, comprising the steps:
performing radio frequency based sensing in a sensing area by a group of at least two nodes of a radio frequency system comprising multiple nodes, wherein a first node of the at least two nodes is configured for transmitting radio frequency signals and a second node of the at least two nodes is configured for receiving the transmitted radio frequency signals, and wherein the radio frequency based sensing is performed by analysing disturbances to the radio frequency signals caused by interaction of the radio frequency signals with one or more objects or persons on their transmission paths between the at least two nodes,
determining a radio frequency system configuration parameter of the radio frequency system configuration parameters which has a larger effect on the detection performance of the radio frequency based sensing than a corresponding adjustment to another radio frequency system configuration parameter, and
adjusting the radio frequency system configuration parameter which has a larger effect on the detection performance of the radio frequency based sensing than a corresponding adjustment to another radio frequency system configuration parameter in order to optimize the detection performance of radio frequency based sensing.

13. The method according to claim 12 comprising one or more of the steps:
determining a current context for performing radio frequency based sensing by the group in the sensing area,
determining the radio frequency system configuration parameter which has a larger effect on the detection performance of the radio frequency based sensing than a corresponding adjustment to another radio frequency system configuration parameter based on the current context,
determining the radio frequency system configuration parameter which has a larger effect on the detection performance of the radio frequency based sensing than a corresponding adjustment to another radio frequency system configuration parameter based on one or more sensing metrics included in the detection performance,
determining whether a respective current sensing metric level of the one or more sensing metrics included in the detection performance is above or below a respective threshold sensing metric level,
determining the radio frequency system configuration parameter which has a larger effect on the detection performance of the radio frequency based sensing than a corresponding adjustment to another radio frequency system configuration parameter based on which of the respective current sensing metric levels of the one or more sensing metrics included in the detection performance is above or below the respective threshold sensing metric level,
determining a current detection performance level of radio frequency based sensing,
optimizing the detection performance based on whether the current detection performance level is above or below a threshold detection performance level,
determining a ranking for the one or more radio frequency system configuration parameters ranked according to how much they respectively affect the detection performance of radio frequency based sensing,
adjusting the radio frequency system configuration parameters based on the ranking in order to optimize the detection performance of radio frequency based sensing,
providing the radio frequency system configuration parameter which has a larger effect on the detection performance of the radio frequency based sensing than a corresponding adjustment to another radio frequency system configuration parameter,
providing how the radio frequency system configuration parameter which has a larger effect on the detection performance of the radio frequency based sensing than a corresponding adjustment to another radio frequency system configuration parameter is to be adjusted for optimizing the detection performance,
providing the radio frequency system configuration parameter which has a larger effect on the detection performance of the radio frequency based sensing than a corresponding adjustment to another radio frequency system configuration parameter to a user, and
providing to the user, how the radio frequency system configuration parameter which has a larger effect on the detection performance of the radio frequency based sensing than a corresponding adjustment to another radio frequency system configuration parameter is to be adjusted for optimizing the detection performance.

14. A computer program product for optimizing detection performance of radio frequency based sensing, wherein the computer program product comprises program code means for causing a processor to carry out the method according to claim 12, when the computer program product is run on the processor.

15. A computer readable medium having stored the computer program product of claim 14.
